(19) United States
(12) Patent Application Publication
(10) Pub. No.: US 2016/0275536 A1
(43) Pub. Date: Sep. 22, 2016

(54) REGULATING DIGITAL CONTENT TRANSMITTED OVER A NETWORK

(71) Applicant: Intel Corporation, Santa Clara, CA (US)

(72) Inventor: Glen J. Anderson, Beaverton, OR (US)

(21) Appl. No.: 14/660,760

(22) Filed: Mar. 17, 2015

(51) Int. Cl. G06Q 30/02; H04L 29/08

(52) U.S. Cl. CPC G06Q 30/0208; G06Q 30/0241; G06Q 30/0272; G06Q 30/0273; H04L 67/02

(57) ABSTRACT

The present disclosure describes embodiments of apparatuses and method for transmitting and receiving digital content over a network. In embodiments, an apparatus may transmit digital content and a task to a user device, receive task performance data, process the data to determine compliance information to the task, and regulate the digital content base at least in part on the compliance information. Other embodiments may be disclosed and/or claimed.

### FIELD

Embodiments of the present disclosure generally relate to the field of systems and methods for transmitting and receiving digital content over a network.

### BACKGROUND

Digital content is typically transmitted over one or more networks to numerous content consumption devices, including televisions and various computing devices such as personal computers, tablets, and smart phones. Digital content includes video and audio content, such as content on cable television, streaming movies, and streaming music. Some digital content may be available by paid prescription service or may be a pay per digital segment, such as a movie. Digital content typically includes commercial advertisements directed towards various products and services. Successful commercials are typified by people actual watching or listening to the commercial and possibly telling others about the commercial. However, viewers and/or listeners of the digital content often times ignore the commercials for various reasons.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a computing apparatus for serving digital content, in accordance with some embodiments.

FIG. 2 schematically illustrates a method for serving digital content by a computing apparatus, in accordance with some embodiments.

FIG. 3 schematically illustrates a non-transitory computer readable storage medium with programming instructions to cause a computing apparatus, in response to execution of the instructions by a processor of the computing apparatus, to practice aspects of embodiments of the processes disclosed herein, in accordance with some embodiments.

FIG. 4 schematically illustrates a computing apparatus for consuming digital content, in accordance with some embodiments.

FIG. 5 schematically illustrates a method for consuming digital content, in accordance with some embodiments.

FIG. 6 schematically illustrates a non-transitory computer readable storage medium with programming instructions to cause a digital content consumption device, in response to execution of the instructions by a processor of the digital content consumption device, to practice aspects of embodiments of the processes disclosed herein, in accordance with some embodiments.

### DETAILED DESCRIPTION

Embodiments of the present disclosure describe apparatuses and methods for serving digital content over a network and associated techniques and configurations. In the following description, various aspects of the illustrative implementations are described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other.

In various embodiments, the phrase “a first feature formed, deposited, or otherwise disposed on a second feature” may mean that the first feature is formed, deposited, or disposed over the second feature, and at least a part of the first feature may be in direct contact (e.g., direct physical and/or electrical contact) or indirect contact (e.g., having one or more other features between the first feature and the second feature) with at least a part of the second feature.

As used herein, the term “module” may refer to, be part of, or include an Application Specific Integrated Circuit (ASIC), an electronic circuit, a system-on-chip (SoC), a processor (shared, dedicated, or group), and/or memory (shared, dedicated, or group) that execute one or more software or firmware programs, a combinational logic circuit, and/or other suitable components that provide the described functionality.

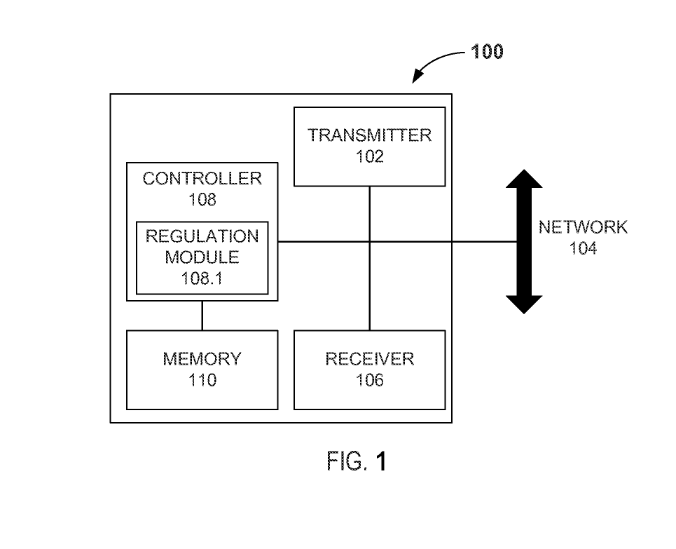

FIG. 1 schematically illustrates a computing apparatus 100 for serving digital content, in accordance with some embodiments. In some embodiments, the computing apparatus 100 may include a transmitter 102 to transmit over a network 104 to a user content consumption device (not shown) a digital content and a task to be performed, a receiver 106 to receive over the network 104 a set of task performance data, where the task is to be performed outside the user content consumption device, and a controller 108 coupled to the receiver 106 and transmitter 102, the controller 108 to process the set of task performance data to determine a compliance information, the compliance information includes whether the task was completed, and the controller 108, at least one of, to store a value in a memory 110 coupled to the controller 108 or to regulate the transmitter 102 to transmit the digital content to the user content consumption device, based at least in part on the compliance information. In some embodiments, the controller 108 may have a regulation module 108.1 to regulate the transmitter, receiver, and/or memory.

In some embodiments, the task may be an instruction to perform one or more of a physical task or a vocal task, outside the user content consumption device. In some embodiments, the physical task may include going to a location. In some embodiments, the instruction further may include a time instruction, the time instruction may be one or more of the task to: begin at a certain time, begin before a certain time, begin after a certain time, end at a certain time, end before a certain time, end after a certain time, and/or complete before a total time has passed. In some embodiments, the instruction further may include to perform one or more of a physical task or a vocal task, by two or more persons. The task is to be performed outside the user content consumption device, wherein outside means that the task does not involving interaction with the user content consumption device, such as clicking a mouse, touching a touch screen, touching a mouse pad, and touching other input devices of the user content consumption device. Outside does include tasks involving physical acts and or vocal acts performed at a distance and/or proximity sufficient to allow a sensor communicatively coupled to the user content consumption device to sense the physical and/or vocal act. By way of example and not limitation, a task may include to say a certain word or make a certain sound and to form a shape using arms. A microphone sensor may sense the sound and a camera may sense the shape. Data representing the sound and shape may be transmitted by a user content consumption device and received by the receiver of the computing apparatus for serving digital content 100 and subsequently processed by the controller 108. By way of example and not limitation, a task may include three people saying a syllable of Budweiser (Bud-weis-er). Data obtained from microphone may be transmitted by a user content consumption device and received by the receiver of the computing apparatus for serving digital content 100 and subsequently processed by the controller 108 to determine compliance information.

In some embodiments, the controller 108 may regulate the transmitter 102 to transmit the digital content with no time delay or with a time delay free from one or more advertisements when the compliance information indicates that the task was completed. In some embodiments, the controller 108 may regulate the transmitter 102 to transmit the digital content with no time delay or with a time delay by interrupting an advertisement segment before the segment is completed when the compliance information indicates that the task was completed. In some embodiments, a completed task may include a partially completed task. In some embodiments, the computing apparatus 100 may include a memory 110 coupled to the controller 108. In some embodiments, the controller 108 may store a value in the memory 110 in response to the compliance information indicating the task was completed, wherein the value may be associated with an account for the user content consumption device. In some embodiments, the value may be accumulated with other values stored previously by the controller 108 to provide an accumulated value in the account for the user content consumption device. In some embodiments, the value is exchangeable for one or more of a discount on products, a discount on services, or free samples. In some embodiments, the controller 108 may transmit over the network 104 the compliance information to the user content consumption device. In some embodiments, the digital content may be a digital video content or an audio digital content. In some embodiments, the computing apparatus 100 may be two or more computing devices coupled together by one or more networks. In some embodiments, the network may include one or more wireless networks. In some embodiments, the network may include one or more wired networks. In some embodiments, the network may include one or more wireless networks and one or more wired networks.

In some embodiments, the task may need to be performed by one person. In some embodiments, the task may need to be performed by more than one person. In some embodiments, the task may need to be performed by a user of the user content consumption device. In some embodiments, the task may need to be performed by a user of the user content consumption device and one or more additional persons. In some embodiments, the user is a registered user of the content consumption device and is associated with an account for the user consumption device. In some embodiments, one or more unique identifiers identify the user of the content consumption device and are associated with the account for a user content consumption device. In some embodiments, the unique identifiers may include one or more of a password, fingerprint, voice recognition, and facial recognition, or some other unique identifier.

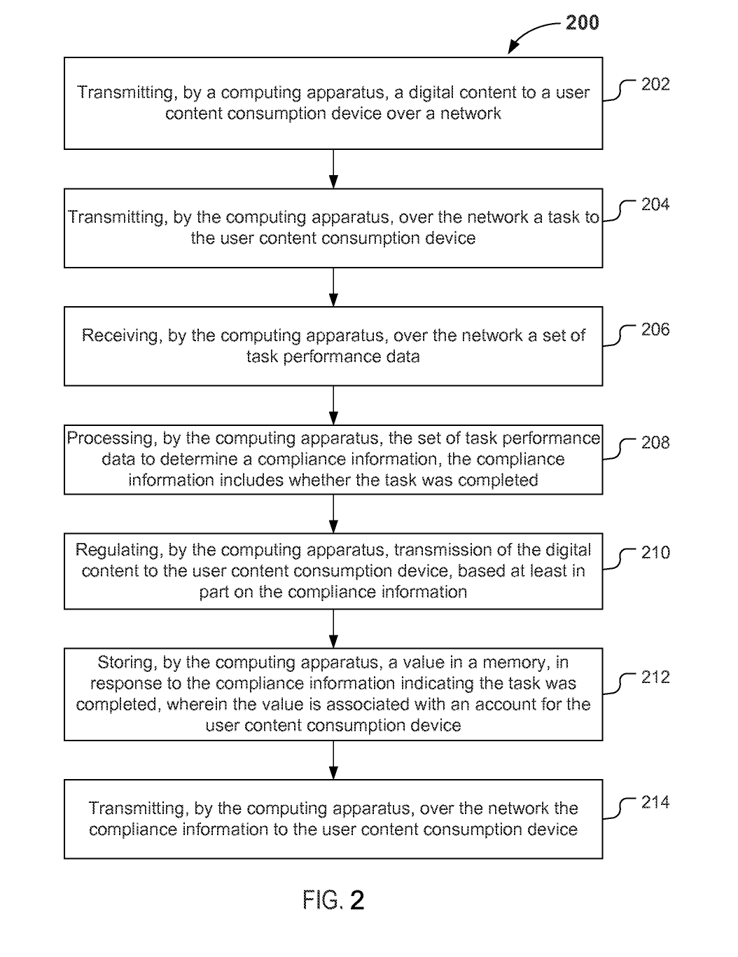

FIG. 2 schematically illustrates a method 200 for serving digital content by a computing apparatus, in accordance with some embodiments. In some embodiments, the method 200 may include transmitting, by the computing apparatus, a digital content to a user content consumption device over a network 202, transmitting, by the computing apparatus, over the network a task to the user content consumption device 204, receiving, by the computing apparatus, over the network a set of task performance data 206, processing, by the computing apparatus, the set of task performance data to determine a compliance information, the compliance information includes whether the task was completed 208, and regulating, by the computing apparatus, transmission of the digital content to the user content consumption device, based at least in part on the compliance information 210. In some embodiments, the method 200 further may include storing, by the computing apparatus, a value in a memory, in response to the compliance information indicating the task was completed, wherein the value is associated with an account for the user content consumption device 212. In some embodiments, the method 200 further may include transmitting, by the computing apparatus, over the network the compliance information to the user content consumption device 214. In some embodiments, regulating 210 further may include transmitting the digital content free from one or more advertisement content segments to the user content consumption device in response to the compliance information indicating the task was completed. In some embodiments, regulating 210 further may include transmitting the digital content by interrupting an advertisement content segment to the user content consumption device in response to the compliance information indicating the task was completed. In some embodiments, the digital content is digital video content and/or digital audio content. In some embodiments, the task is not transmitted until the computing device receives from a content consumption device an opt-in notice. Various operations of FIG. 2 are described as multiple discrete operations in turn, in a manner that is most helpful in understanding the claimed subject matter. However, the order of description should not be construed as to imply that these operations are necessarily order dependent.

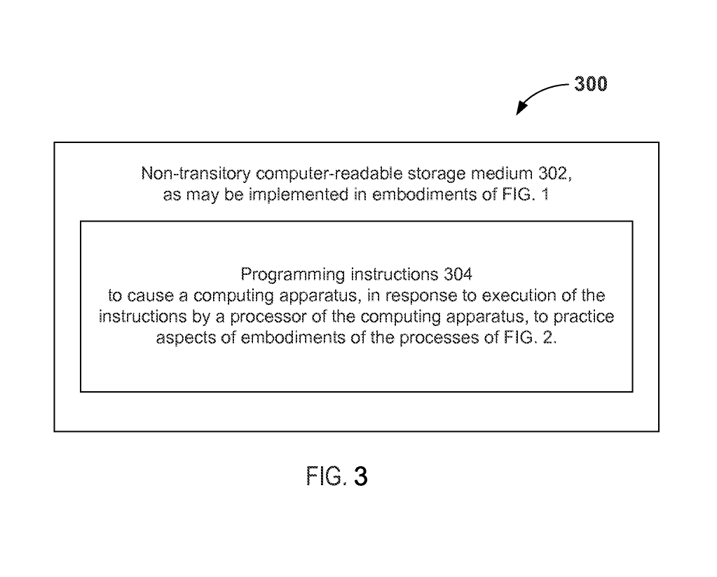

FIG. 3 schematically illustrates a non-transitory computer readable storage medium 302 with programming instructions 304 to cause a computing apparatus, in response to execution of the instructions by a processor of the computing apparatus, to practice aspects of embodiments of the processes disclosed herein, in accordance with some embodiments 300. In some embodiments, the non-transitory computer readable storage medium (medium) 302 with the programming instructions 304 may be implemented in some embodiments of the computing apparatus 100 illustrated in FIG. 1 to practice aspects of the embodiments of the method 200 illustrated in FIG. 2, as further disclosed and described herein. In some embodiments, the programming instructions may cause the computing apparatus, to transmit a first digital content to a user content consumption device over a network, transmit over the network a task to the user content consumption device, receive over the network a set of task performance data, process the set of task performance data to determine a compliance information, the compliance information includes whether the task was completed, and transmit over the network the first digital content or a second digital content, based at least in part the compliance information. In alternate embodiments, programming instructions 304 may be encoded in transitory computer-readable medium, such as signals.

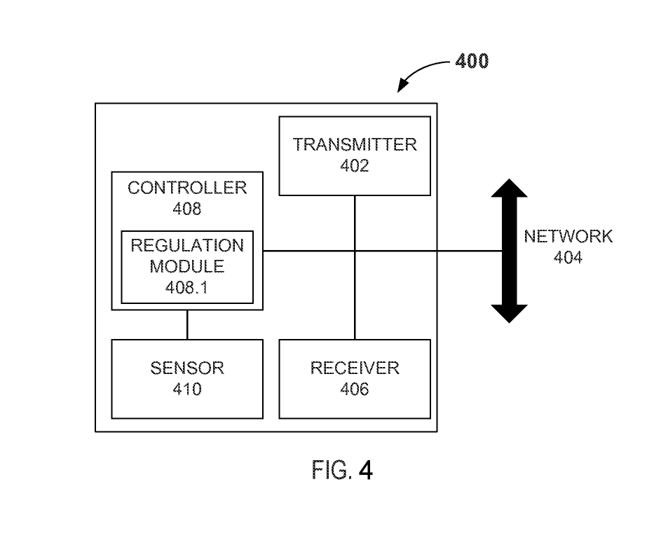

FIG. 4 schematically illustrates a computing apparatus 400 for consuming digital content, in accordance with some embodiments. In some embodiments, the computing apparatus 400 for consuming digital content may include a receiver 406 to receive over a network 404 a first digital content, a second digital content, and a task, one or more sensors 410 to collect a set of task performance data when the task is performed, a transmitter 402 to transmit over the network 404 the set of task performance data, a controller 408 coupled to the receiver 406, the one or more sensors 410, and the transmitter 402, the controller 408 to communicate the task and to regulate the transmitter 402 to transmit over the network 404 the set of task performance data, wherein the second digital content is different from the first digital content, based at least in part on completion of the task or attempt to complete the task. In some embodiments, the controller 408 may have a regulation module 408.1 to regulate the transmitter, receiver, and/or sensors. In some embodiments, the receiver 406 further is to receive a compliance software code, the controller 408 further is to process the set of task performance data using the compliance software code to determine a compliance information, the compliance information includes whether the task was completed and further to regulate the transmitter 402 to transmit over the network the compliance information instead of the set of task performance data. In some embodiments, the one or more sensors 410 may include one or more of camera, accelerometer, gyroscope, acoustic, GPS, microphone, motion, light, temperature, pressure, IR, brain-computer interface, conductivity, and/or moisture. In alternate embodiments, one or more sensors 410 may be physically disposed away from controller 408, but communicatively coupled with controller 408.

In some embodiments, one or more sensors 410 may include brain-computer interface sensors that are improved by technological advances in sensing brain or neuronal activity signal opportunities. In some embodiments, brain-computer interface sensors may be based on temporal and spatial patterns of biophysical signals obtained through but not limited to electrical (e.g., electroencephalography or EEG), fluidic (e.g., functional near-infrared spectroscopy or fNIRS), or magnetic (e.g., magnetoencephalography or MEG). In some embodiments, brain-computer interface sensors may be based on measurements and identification of psychological states or mental representations of a person to reveal information like cognitive workload, attention/distraction, mood, sociological dynamics, memories, and others.

In some embodiments, the computing apparatus 400 further may include one or more computing devices, wherein the one or more computing devices may include one or more of wearable electronic devices or non-wearable electronic devices. In some embodiments, the one or more sensors 410 may be coupled to the one or more computing devices or distributed to the wearable/non-wearable electronic devices. In some embodiments, the wearable electronic devices may include smart phones, activity tracker devices, GPS devices, physiology tracking devices, smart shoes, smart glasses, smart clothing, and smart accessories. In some embodiments, the non-wearable electronic devices may include smart televisions and fixed cameras.

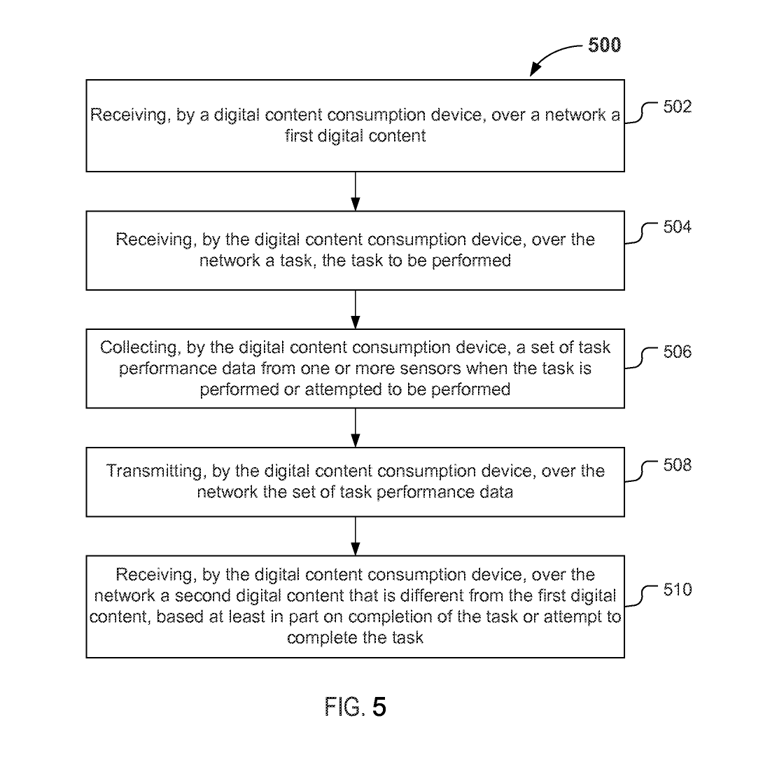

FIG. 5 schematically illustrates a method 500 for consuming digital content, in accordance with some embodiments. In some embodiments, the method for consuming digital content may include receiving, by a digital content consumption device, over a network a first digital content 502, receiving, by the digital content consumption device, over the network a task, the task to be performed 504 outside the digital content consumption device, collecting, by the digital content consumption device, a set of task performance data from one or more sensors when the task is performed or attempted to be performed 506, transmitting, by the digital content consumption device, over the network the set of task performance data 508, and receiving, by the digital content consumption device, over the network a second digital content that is different from the first digital content, based at least in part on completion of the task or attempt to complete the task 510. In some embodiments, the method 500 further may include receiving, by the digital content consumption device, a compliance software code, processing, by the digital content consumption device, the set of task performance data using the compliance software code to determine a compliance information, the compliance information includes whether the task was completed, and transmitting, by the digital content consumption device, over the network the compliance information instead of the set of task performance data. In some embodiments, the second digital content is one of advertisement content segment free or advertisement content segment interrupted. In some embodiments, the task includes one or more of performing a physical task, performing a vocal task, going to a location, beginning at, before, or after a certain time, ending at, before, or after a certain time, and completing before a total time has passed.

In some embodiments, the task is to be performed by one or more persons. In some embodiments, the task is not received until the user consumption device transmits an opt-in notice. Various operations of FIG. 5 are described as multiple discrete operations in turn, in a manner that is most helpful in understanding the claimed subject matter. However, the order of description should not be construed as to imply that these operations are necessarily order dependent.

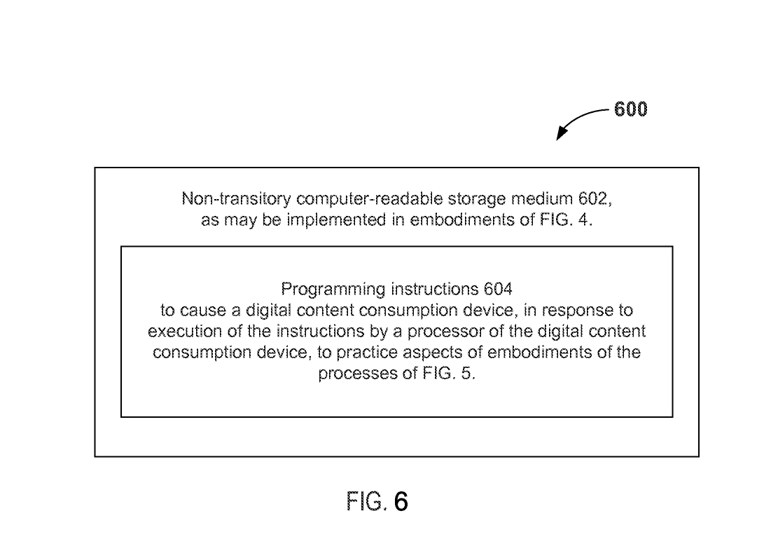

FIG. 6 schematically illustrates a non-transitory computer readable storage medium 602 with programming instructions 604 to cause a digital content consumption device, in response to execution of the instructions by a processor of the digital content consumption device, to practice aspects of embodiments of the processes disclosed herein, in accordance with some embodiments 600. In some embodiments, the non-transitory computer readable storage medium (medium) 602 with the programming instructions 604 may be implemented in some embodiments of the digital content consumption device 400 illustrated in FIG. 4 to practice aspects of the embodiments of the method 500 illustrated in FIG. 5, as further disclosed and described herein. In some embodiments, the programming instructions may cause the digital content consumption device, to receive over a network a first digital content, receive over the network a task, the task to be performed, collect a set of task performance data obtained from one or more sensors collecting the data when the task is performed or attempted to be performed, transmit over the network the set of task performance data, and receive over the network a second digital content, based at least in part on completion of the task. In alternate embodiments, programming instructions 604 may be encoded in transitory computer-readable medium, such as signals.

### EXAMPLES

According to various embodiments, the present disclosure describes a number of examples. Example 1 is a computing apparatus for serving digital content, comprising: a transmitter to transmit over a network to a user content consumption device a digital content and a task to be performed outside the user content consumption device; a receiver to receive over the network a set of task performance data or a compliance information; and a controller coupled to the receiver and transmitter, the controller to process the set of task performance data to determine the compliance information when not received by the receiver, the compliance information includes whether the task was completed, and the controller, at least one of, to store a value in a memory coupled to the controller and to regulate the transmitter to transmit the digital content to the user content consumption device, based at least in part on the compliance information.

Example 2 may include the subject matter of Example 1 and other examples herein, wherein the task is an instruction to perform one or more of a physical task or a vocal task outside the user content consumption d.

Example 3 may include the subject matter of Example 2 and other examples herein, wherein the instruction further includes a time instruction, wherein the time instruction is one or more of the task to: begin at a certain time, begin before a certain time, begin after a certain time, end at a certain time, end before a certain time, end after a certain time, or complete before a total time has passed.

Example 4 may include the subject matter of Example 2 and other examples herein, wherein the instruction further includes to perform one or more of a physical task or a vocal task, by two or more persons, outside the user content consumption device..

Example 5 may include the subject matter of Example 1 and other examples herein, wherein the controller is to regulate the transmitter to transmit the digital content with no time delay or with a time delay, advertisement content segment free, to the user content consumption device, in response to the compliance information indicating the task was completed.

Example 6 may include the subject matter of Example 1 and other examples herein, wherein the controller is to regulate the transmitter to transmit the digital content with no time delay or with a time delay, advertisement content segment interrupted, to the user content consumption device, in response to the compliance information indicating the task was completed.

Example 7 may include the subject matter of Example 1 and other examples herein, wherein the value is associated with an account for the user content consumption device and is exchangeable for one or more of a discount on products, a discount on services, and free samples.

Example 8 may include the subject matter of Example 1 and other examples herein, wherein the controller is to further cause the transmitter to transmit over the network the compliance information to the user content consumption device.

Example 9 may include the subject matter of Example 1 and other examples herein, wherein the digital content is a digital video content.

Example 10 is a method for serving digital content by a computing apparatus, comprising: transmitting, by the computing apparatus, a digital content to a user content consumption device over a network; transmitting, by the computing apparatus, over the network a task to the user content consumption device, to be performed outside the user content consumption device; receiving, by the computing apparatus, over the network a set of task performance data or a compliance information; processing, by the computing apparatus, the set of task performance data to determine the compliance information when not received, the compliance information includes whether the task was completed; and at least one of (i) regulating, by the computing apparatus, transmission of the digital content to the user content consumption device, based at least in part on the compliance information or (ii) storing, by the computing apparatus, a value in a memory, in response to the compliance information indicating the task was completed, wherein the value is associated with an account for the user content consumption device.

Example 11 may include the subject matter of Example 10 and other examples herein, wherein the task is an instruction to perform one or more of a physical task or a vocal task outside the user content consumption device.

Example 12 may include the subject matter of Example 11 and other examples herein, wherein the instruction further includes a time instruction, the time instruction is one or more of the task to: begin at a certain time, begin before a certain time, begin after a certain time, end at a certain time, end before a certain time, end after a certain time, or complete before a total time has passed, outside the user content consumption device.

Example 13 may include the subject matter of Example 11 and other examples herein, wherein the instruction further includes to perform one or more of a physical task or a vocal task, by two or more persons.

Example 14 may include the subject matter of Example 10 and other examples herein, wherein regulating further includes transmitting the digital content with no time delay or with a time delay, advertisement content segment free, to the user content consumption device, in response to the compliance information indicating the task was completed.

Example 15 may include the subject matter of Example 10 and other examples herein, wherein regulating further includes transmitting the digital content with no time delay or with a time delay, advertisement content segment interrupted, to the user content consumption device, in response to the compliance information indicating the task was completed.

Example 16 may include the subject matter of Example 10 and other examples herein, wherein the value is associated with an account for the user content consumption device and is exchangeable for one or more of a discount on products, a discount on services, and free samples.

Example 17 may include the subject matter of Example 10 and other examples herein, wherein the digital content is digital video content.

Example 18 is one or more non-transitory computer readable media comprising instructions to cause a computing apparatus, in response to execution of the instructions by a processor of the computing apparatus, to: transmit a first digital content to a user content consumption device over a network; transmit over the network a task to the user content consumption device, to be performed outside the user content consumption device; receive over the network a set of task performance data or a compliance information; process the set of task performance data to determine the compliance information when not received, the compliance information includes whether the task was completed; and at least one of (i) transmit over the network the first digital content or a second digital content, based at least in part the compliance information or (ii) store a value in a memory, in response to the compliance information indicating the task was completed, wherein the value is associated with an account for the user content consumption device.

Example 19 may include the subject matter of Example 18 and other examples herein, wherein the task is an instruction to perform one or more of a physical task or a vocal task outside the user content consumption device.

Example 20 may include the subject matter of Example 19 and other examples herein, wherein the instruction further includes a time instruction, the time instruction is one or more of the task to: begin at a certain time, begin before a certain time, begin after a certain time, end at a certain time, end before a certain time, end after a certain time, or complete before a total time has passed.

Example 21 may include the subject matter of Example 19 and other examples herein, wherein the instruction further includes to perform one or more of a physical task or a vocal task, by two or more persons, outside the user content consumption device.

Example 22 may include the subject matter of Example 18 and other examples herein, further comprising instructions to cause the computing apparatus, in response to execution of the instructions by the processor of the computing apparatus, to: transmit the digital content with no time delay or with a time delay, advertisement content segment free, to the user content consumption device, in response to the compliance information indicating the task was completed.

Example 23 may include the subject matter of Example 18 and other examples herein, further comprising instructions to cause the computing apparatus, in response to execution of the instructions by the processor of the computing apparatus, to: transmit the digital content with no time delay or with a time delay, advertisement content segment interrupted, to the user content consumption device, in response to the compliance information indicating the task was completed.

Example 24 may include the subject matter of Example 18 and other examples herein, wherein the value is associated with an account for the user content consumption device and is exchangeable for one or more of a discount on products, a discount on services, and free samples.

Example 25 may include the subject matter of Example 18 and other examples herein, wherein the digital content is digital video content.

Example 26 is a computing apparatus for serving digital content, comprising: transmit means for transmitting over a network to a user content consumption device a digital content and a task to be performed outside the user content consumption device; receive means for receiving over the network a set of task performance data or a compliance information; process means for processing the set of task performance data to determine the compliance information when not received by the receiver, the compliance information includes whether the task was completed; and at least one of (i) control means for regulating the transmitter for transmitting the digital content to the user content consumption device, based at least in part on the compliance information or (ii) control means for storing a value in a memory.

Example 27 may include the subject matter of Example 26 and other examples herein, wherein the task is an instruction to perform one or more of a physical task and a vocal task, outside the user content consumption device.

Example 28 may include the subject matter of Example 27 and other examples herein, wherein the instruction further includes a time instruction, the time instruction is one or more of the task to: begin at a certain time, begin before a certain time, begin after a certain time, end at a certain time, end before a certain time, end after a certain time, or complete before a total time has passed.

Example 29 may include the subject matter of Example 28 and other examples herein, wherein the instruction further includes to perform one or more of a physical task and a vocal task, by two or more persons, outside the user content consumption device.

Example 30 may include the subject matter of Example 26 and other examples herein, further comprising: control means for regulating the transmitter to transmit the digital content with no time delay or with a time delay, advertisement content segment free, to the user content consumption device, in response to the compliance information indicating the task was completed.

Example 31 may include the subject matter of Example 26 and other examples herein, further comprising: control means for regulating the transmitter to transmit the digital content with no time delay or with a time delay, advertisement content segment interrupted, to the user content consumption device, in response to the compliance information indicating the task was completed.

Example 32 may include the subject matter of Example 26 and other examples herein, wherein the value is associated with an account for the user content consumption device and is exchangeable for one or more of a discount on products, a discount on services, and free samples.

Example 33 may include the subject matter of Example 26 and other examples herein, further comprising: control means for regulating transmitter to transmit over the network the compliance information to the user content consumption device.

Example 34 may include the subject matter of Example 26 and other examples herein, wherein the digital content is a digital video content.

Example 35 is a computing apparatus for consuming digital content, comprising: a receiver to receive over a network a first digital content, a second digital content, and a task, wherein the task is to be performed outside the computing apparatus for consuming digital content; one or more sensors to collect a set of task performance data when the task is performed; a transmitter to transmit over the network the set of task performance data; and a controller coupled to the receiver, the one or more sensors, the processor, and the transmitter, the controller to communicate the first and second digital content and the task and to regulate the transmitter to transmit over the network the set of task performance data, wherein the second digital content is different from the first digital content, based at least in part on completion of the task or attempt to complete the task.

Example 36 may include the subject matter of Example 35 and other examples herein, wherein the receiver further is to receive a compliance software code, the controller further is to process the set of task performance data using the compliance software code to determine a compliance information, the compliance information includes whether the task was completed and further to regulate the transmitter to transmit over the network the compliance information instead of the set of task performance data.

Example 37 may include the subject matter of Example 35 and other examples herein, wherein the one or more sensors include camera, accelerometer, gyroscope, acoustic, GPS, microphone, motion, light, temperature, pressure, IR, brain-computer interface, conductivity, or moisture.

Example 38 may include the subject matter of Example 35 and other examples herein, further comprising one or more computing devices, wherein the one or more computing devices include one or more of wearable electronic devices or non-wearable electronic devices.

Example 39 may include the subject matter of Example 38 and other examples herein, wherein the one or more sensors are coupled to the one or more computing devices.

Example 40 may include the subject matter of Example 38 and other examples herein, wherein the wearable electronic devices include smart phones, activity tracker devices, GPS devices, physiology tracking devices, smart shoes, smart glasses, smart clothing, or smart accessories.

Example 41 may include the subject matter of Example 38 and other examples herein, wherein the non-wearable electronic devices include smart televisions and fixed cameras.

Example 42 may include the subject matter of Example 38 and other examples herein, wherein the one or more sensors include camera, accelerometer, gyroscope, acoustic, GPS, microphone, motion, light, temperature, pressure, IR, brain-computer interface, conductivity, or moisture.

Example 43 is a method for consuming digital content, comprising: receiving, by a digital content consumption device, over a network a first digital content; receiving, by the digital content consumption device, over the network a task, the task to be performed outside the digital content consumption device; collecting, by the digital content consumption device, a set of task performance data from one or more sensors when the task is performed or attempted to be performed; transmitting, by the digital content consumption device, over the network the set of task performance data; and receiving, by the digital content consumption device, over the network a second digital content that is different from the first digital content, based at least in part on completion of the task or attempt to complete the task.

Example 44 may include the subject matter of Example 43 and other examples herein, further comprising: receiving, by the digital content consumption device, a compliance software code; processing, by the digital content consumption device, the set of task performance data using the compliance software code to determine a compliance information, the compliance information includes whether the task was completed; and transmitting, by the digital content consumption device, over the network the compliance information instead of the set of task performance data.

Example 45 may include the subject matter of Example 43 and other examples herein, wherein the second digital content is one of advertisement content segment free or advertisement content segment interrupted.

Example 46 may include the subject matter of Example 43 and other examples herein, wherein the task is an instruction to perform one or more of a physical task or a vocal task, outside the user content consumption device.

Example 47 may include the subject matter of Example 46 and other examples herein, wherein the instruction further includes a time instruction, the time instruction is one or more of the task to: begin at a certain time, begin before a certain time, begin after a certain time, end at a certain time, end before a certain time, end after a certain time, or complete before a total time has passed.

Example 48 may include the subject matter of Example 46 and other examples herein, wherein the instruction further includes to perform one or more of a physical task or a vocal task, by two or more persons, outside the user content consumption device.

Example 49 is one or more non-transitory computer readable media comprising instructions to cause a digital content consumption device, in response to execution of the instructions by a processor of the digital content consumption device, to: receive over a network a first digital content; receive over the network a task, the task to be performed outside the digital content consumption device; collect a set of task performance data obtained from one or more sensors collecting the data when the task is performed or attempted to be performed; transmit over the network the set of task performance data; and receive over the network a second digital content, based at least in part on completion of the task.

Example 50 may include the subject matter of Example 49 and other examples herein, wherein the second digital content is one of advertisement content segment free or advertisement content segment interrupted.

Example 51 may include the subject matter of Example 49 and other examples herein, further comprising instructions to cause the computing apparatus, in response to execution of the instructions by the processor of the computing apparatus, to: receive a compliance software code; process the set of task performance data using the compliance software code to determine a compliance information, the compliance information includes whether the task was completed; and transmit over the network the compliance information instead of the set of task performance data.

Example 52 may include the subject matter of Example 49 and other examples herein, wherein the second digital content is one of advertisement content segment free or advertisement content segment interrupted.

Example 53 may include the subject matter of Example 49 and other examples herein, wherein the task is an instruction to perform one or more of a physical task or a vocal task, outside the user content consumption device.

Example 54 may include the subject matter of Example 53 and other examples herein, wherein the instruction further includes a time instruction, the time instruction is one or more of the task to: begin at a certain time, begin before a certain time, begin after a certain time, end at a certain time, end before a certain time, end after a certain time, or complete before a total time has passed.

Example 55 may include the subject matter of Example 53 and other examples herein, wherein the instruction further includes to perform one or more of a physical task or a vocal task, by two or more persons.

Example 56 is a computing apparatus for consuming digital content, comprising: receive means for receiving over a network a first digital content; receive means for receiving over the network a task, wherein the task is outside the computing apparatus for consuming digital content; communicate means for communicating the task; collect means for collecting from one or more sensors a set of task performance data when the task is performed or attempted to be performed; transmit means for transmitting over the network the set of task performance data; and receive means for receiving over the network a second digital content that is different from the first digital content, based at least in part on completion of the task or attempt to complete the task.

Example 57 may include the subject matter of Example 56 and other examples herein, further comprising: receive means for receiving a compliance software code; and process means for processing the set of task performance data using the compliance software code to determine a compliance information, the compliance information includes whether the task was completed and further to regulate the transmitter to transmit over the network the compliance information instead of the set of task performance data.

Example 58 may include the subject matter of Example 56 and other examples herein, wherein the one or more sensors include camera, accelerometer, gyroscope, acoustic, GPS, microphone, motion, light, temperature, pressure, IR, brain-computer interface, conductivity, or moisture.

What is claimed is:

1. A computing apparatus for serving digital content, comprising:
a transmitter to transmit over a network to a user content consumption device a digital content and a task to be performed outside the user content consumption device;
a receiver to receive over the network a set of task performance data or a compliance information; and
a controller coupled to the receiver and transmitter, the controller to process the set of task performance data to determine the compliance information when not received by the receiver, the compliance information includes whether the task was completed, and the controller, at least one of, to store a value in a memory coupled to the controller and to regulate the transmitter to transmit the digital content to the user content consumption device, based at least in part on the compliance information.

2. The apparatus of claim 1, wherein the task is an instruction to perform one or more of a physical task or a vocal task outside the user content consumption device.

3. The apparatus of claim 2, wherein the instruction further includes a time instruction, wherein the time instruction is one or more of the task to: begin at a certain time, begin before a certain time, begin after a certain time, end at a certain time, end before a certain time, end after a certain time, or complete before a total time has passed.

4. The apparatus of claim 1, wherein the controller is to regulate the transmitter to transmit the digital content with no time delay or with a time delay, advertisement content segment free or advertisement content segment interrupted, to the user content consumption device, in response to the compliance information indicating the task was completed.

5. The apparatus of claim 1, wherein the value is associated with an account for the user content consumption device and is exchangeable for one or more of a discount on products, a discount on services, and free samples.

6. The apparatus of claim 1, wherein the controller is to further cause the transmitter to transmit over the network the compliance information to the user content consumption device.

7. A method for serving digital content by a computing apparatus, comprising:
transmitting, by the computing apparatus, a digital content to a user content consumption device over a network;
transmitting, by the computing apparatus, over the network a task to the user content consumption device to be performed outside the user content consumption device;
receiving, by the computing apparatus, over the network a set of task performance data or a compliance information;
processing, by the computing apparatus, the set of task performance data to determine the compliance information when not received, the compliance information includes whether the task was completed; and
at least one of (i) regulating, by the computing apparatus, transmission of the digital content to the user content consumption device, based at least in part on the compliance information or (ii) storing, by the computing apparatus, a value in a memory, in response to the compliance information indicating the task was completed, wherein the value is associated with an account for the user content consumption device.

8. The method of claim 7, wherein the task is an instruction to perform one or more of a physical task or a vocal task outside the user content consumption device.

9. The method of claim 9, wherein the instruction further includes a time instruction, the time instruction is one or more of the task to: begin at a certain time, begin before a certain time, begin after a certain time, end at a certain time, end before a certain time, end after a certain time, or complete before a total time has passed.

10. The method of claim 7, wherein regulating further includes transmitting the digital content with no time delay or with a time delay, advertisement content segment free or, advertisement content segment interrupted, to the user content consumption device, in response to the compliance information indicating the task was completed.

11. The method of claim 7, wherein the value is associated with an account for the user content consumption device and is exchangeable for one or more of a discount on products, a discount on services, and free samples.

12. A computing apparatus for consuming digital content, comprising:
a receiver to receive over a network a first digital content, a second digital content, and a task, wherein the task is to be performed outside the computing apparatus for consuming digital content;
one or more sensors to collect a set of task performance data when the task is performed;
a transmitter to transmit over the network the set of task performance data; and
a controller coupled to the receiver, the one or more sensors, the processor, and the transmitter, the controller to communicate the first and second digital content and the task and to regulate the transmitter to transmit over the network the set of task performance data,
wherein the second digital content is different from the first digital content, based at least in part on completion of the task or attempt to complete the task.

13. The apparatus of claim 12, wherein the receiver further is to receive a compliance software code, the controller further is to process the set of task performance data using the compliance software code to determine a compliance information, the compliance information includes whether the task was completed and further to regulate the transmitter to transmit over the network the compliance information instead of the set of task performance data.

14. The apparatus of claim 12, wherein the one or more sensors include camera, accelerometer, gyroscope, acoustic, GPS, microphone, motion, light, temperature, pressure, IR, brain-computer interface, conductivity, or moisture.

15. The apparatus of claim 12, further comprising one or more computing devices, wherein the one or more computing devices include one or more of wearable electronic devices or non-wearable electronic devices.

16. The apparatus of claim 15, wherein the one or more sensors are coupled to the one or more computing devices.

17. The apparatus of claim 15, wherein the wearable electronic devices include smart phones, activity tracker devices, GPS devices, physiology tracking devices, smart shoes, smart glasses, smart clothing, or smart accessories.

18. The apparatus of claim 15, wherein the non-wearable electronic devices include smart televisions and fixed cameras.

19. The apparatus of claim 15, wherein the one or more sensors include camera, accelerometer, gyroscope, acoustic, GPS, microphone, motion, light, temperature, pressure, IR, brain-computer interface, conductivity, or moisture.

20. A method for consuming digital content, comprising:
receiving, by a digital content consumption device, over a network a first digital content;
receiving, by the digital content consumption device, over the network a task, the task to be performed outside the digital content consumption device;
collecting, by the digital content consumption device, a set of task performance data from one or more sensors when the task is performed or attempted to be performed;
transmitting, by the digital content consumption device, over the network the set of task performance data; and
receiving, by the digital content consumption device, over the network a second digital content that is different from the first digital content, based at least in part on completion of the task or attempt to complete the task.

21. The method of claim 20, further comprising:
receiving, by the digital content consumption device, a compliance software code;
processing, by the digital content consumption device, the set of task performance data using the compliance software code to determine a compliance information, the compliance information includes whether the task was completed; and
transmitting, by the digital content consumption device, over the network the compliance information instead of the set of task performance data.

22. The method of claim 20, wherein the second digital content is one of advertisement content segment free or advertisement content segment interrupted.

23. The method of claim 20, wherein the task is an instruction to perform one or more of a physical task or a vocal task, outside the user content consumption device.

24. The method of claim 20, wherein the instruction further includes a time instruction, the time instruction is one or more of the task to: begin at a certain time, begin before a certain time, begin after a certain time, end at a certain time, end before a certain time, end after a certain time, or complete before a total time has passed.

25. The method of claim 20, wherein the instruction further includes to perform one or more of a physical task or a vocal task, by two or more persons, outside the user content consumption device.
